(19) United States
(12) Patent Application Publication
(10) Pub. No.: US 2017/0132573 A1
(43) Pub. Date: May 11, 2017

(54) METHOD, SYSTEM AND NON-TRANSITORY COMPUTER-READABLE RECORDING MEDIUM FOR PROVIDING INFORMATION ON EXPENSE MANAGEMENT

(71) Applicant: TENQUBE Co., Ltd., Seoul (KR)

(72) Inventors: Kwang Jin LEE, Seoul (KR); Seoul KIM, Seoul (KR)

(73) Assignee: TENQUBE Co., Ltd., Seoul (KR)

(21) Appl. No.: 15/349,130

(22) Filed: Nov. 11, 2016

(30) Foreign Application Priority Data
Nov. 11, 2015 (KR) 10-2015-0157915

(51) Int. Cl. G06Q 10/10; G06Q 20/14

(52) U.S. Cl. CPC G06Q 10/1093; G06Q 20/14

(57) ABSTRACT

According to one aspect of the present invention, there are provided a method, system and non-transitory computer-readable recording medium for providing information on expense management. According to the invention, a user may accurately track an expense expected to be incurred in an event included in a schedule planned by the user, and may plan the schedule in conformity with a budget or policy of the user based on the expected expense.

### CROSS-REFERENCE TO RELATED APPLICATIONS

This application claims priority to Korean Patent Application No. 10-2015-0157915, filed on Nov. 11, 2015, the entire contents of which are hereby incorporated by reference.

### FIELD

The present invention relates to a method, system and non-transitory computer-readable recording medium for providing information on expense management.

### BACKGROUND

Tracking expenses to be incurred in scheduled events may be important to schedule planners. Conventional techniques for providing a user with various types of information regarding an expense have been introduced so far. However, these conventional techniques have failed to imply any association between information on the expenses and the scheduled events. Thus, to estimate expenses to be incurred in scheduled events, or to plan a schedule that comes in under budget, the user cannot avoid the inconvenience of searching through a history of expense items which are considered to be associated with the user's schedule, item by item. Further, relying on the user's judgment may lead to inaccuracies in estimating the expenses.

Therefore, the inventor(s) present a technique for assisting a user to efficiently manage a schedule based on an expense history.

### SUMMARY

One object of the present invention is to solve all the above problems in prior art.

Another object of the invention is to assist a user to manage a schedule based on an expense history, by acquiring expense history information and schedule information of the user, and determining an expense expected to be incurred in an object event included in the schedule information, with reference to context information on at least one expense unit associated with the object event among expense units included in the expense history information.

According to one aspect of the invention to achieve the objects as described above, there is provided a method for providing information on expense management, comprising the steps of: acquiring expense history information and schedule information of a user; and determining an expense expected to be incurred in an object event included in the schedule information, with reference to context information on at least one expense unit associated with the object event among expense units included in the expense history information.

According to another aspect of the invention, there is provided a method for providing information on expense management, comprising the steps of: acquiring expense history information and location history information of a user; and determining an expense expected to be incurred in an object location or object route derived from the location history information, with reference to context information on at least one expense unit associated with the object location or object route among expense units included in the expense history information.

According to yet another aspect of the invention, there is provided a system for providing information on expense management, comprising: an information acquisition unit for acquiring expense history information and schedule information of a user; and an expense analysis unit for determining an expense expected to be incurred in an object event included in the schedule information, with reference to context information on at least one expense unit associated with the object event among expense units included in the expense history information.

According to still another aspect of the invention, there is provided a system for providing information on expense management, comprising: an information acquisition unit for acquiring expense history information and location history information of a user; and an expense analysis unit for determining an expense expected to be incurred in an object location or object route derived from the location history information, with reference to context information on at least one expense unit associated with the object location or object route among expense units included in the expense history information.

In addition, there are further provided other methods and systems to implement the invention, as well as non-transitory computer-readable recording media having stored thereon computer programs for executing the methods.

According to the invention, a user may accurately track an expense expected to be incurred in an event included in a schedule planned by the user, and may plan the schedule in conformity with a budget or policy of the user based on the expected expense.

According to the invention, a user may more accurately track an expense expected to be incurred in an event included in a schedule of the user, and a recommendation for the schedule may be provided in conformity with a budget or policy of the user, because the expected expense may be determined with further reference to information on other events included in the schedule of the user.

According to the invention, an expense to be incurred in a location or route of a user may be estimated, and thus there may be provided a variety of services such as recommending a route or vehicle based on the expected expense.

### BRIEF DESCRIPTION OF THE DRAWINGS

FIG. 1 schematically shows the configuration of an entire system for providing information on expense management according to one embodiment of the invention.

FIG. 2 illustrates the internal configuration of an information provision system according to one embodiment of the invention.

FIG. 3 illustrates how to analyze expected expenses according to one embodiment of the invention.

FIGS. 4A and 4B illustrates how to recommend a schedule with reference to expected expenses according to one embodiment of the invention.

FIG. 5 illustrates how to provide a recommendation for a route with reference to expected expenses according to another embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the disclosed embodiments may also be modified without departing from the spirit and scope of the invention. Therefore, the following detailed description is not to be taken in a limiting sense, and the scope of the invention, if properly described, is limited only by the appended claims together with all equivalents thereof. In the drawings, like reference numerals refer to the same or similar functions throughout the several views.

Hereinafter, preferred embodiments of the present invention will be described in detail with reference to the accompanying drawings to enable those skilled in the art to easily implement the invention.

Configuration of the Entire System

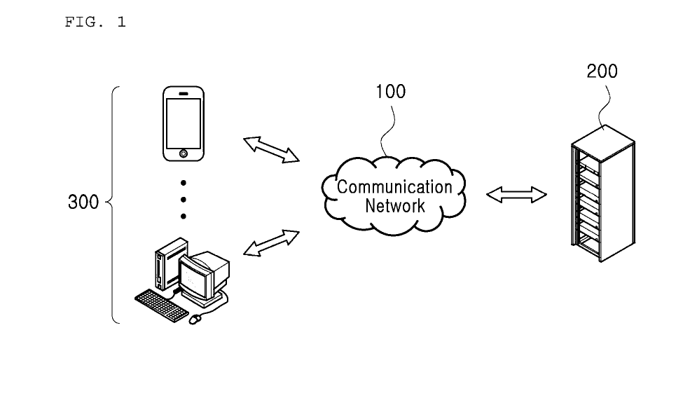

FIG. 1 schematically shows the configuration of an entire system for providing information on expense management according to one embodiment of the invention.

As shown in FIG. 1, the entire system according to one embodiment of the invention may comprise a communication network 100, an information provision system 200, and a user device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television networks.

Next, the information provision system 200 according to one embodiment of the invention may function to assist a user to manage a schedule based on an expense history, by acquiring expense history information and schedule information of the user, and determining an expense expected to be incurred in an object event included in the schedule information, with reference to context information on at least one expense unit associated with the object event among expense units included in the expense history information.

The configuration and function of the information provision system 200 according to the invention will be discussed in detail in the following description. Meanwhile, although the information provision system 200 has been described as above, the above description is illustrative and it will be apparent to those skilled in the art that at least some of the functions or components required for the information provision system 200 may be implemented or included in the user device 300 or an external server (not shown), as necessary.

Next, the user device 300 according to one embodiment of the invention is digital equipment capable of allowing a user to connect to and then communicate with the information provision system 200, and any type of digital equipment having a microprocessor and memory means for computing capabilities, such as smart phones, tablets, desktop computers, notebook computers, workstations, personal digital assistants (PDAs), web pads, and mobile phones, may be adopted as the user device 300 according to the invention.

Particularly, the user device 300 may include an application (not shown) to assist a user to receive information or services from the information provision system 200. The application may be downloaded from the information provision system 200 or a known web server (not shown). It is apparent that the application may be provided by implementing a calendar GUI of a conventional calendar program (e.g., a calendar GUI for schedule management in Microsoft Outlook), a messaging GUI of a conventional messaging program, a map GUI of a conventional map program, and the like, as necessary. At least a part of the information to construct the various GUIs may be received from the information provision system 200. Meanwhile, the nature of the application may be generally similar to those of an information acquisition unit 210, an expense analysis unit 220, an information provision unit 230, a communication unit 240, and a control unit 250 of the information provision system 200 to be described below. Here, at least a part of the application may be replaced with a hardware or firmware device that may perform substantially equal or equivalent functions, as necessary.

Configuration of the Information Provision System

Hereinafter, the internal configuration of the information provision system 200 crucial for implementing the invention and the functions of the respective components thereof will be discussed.

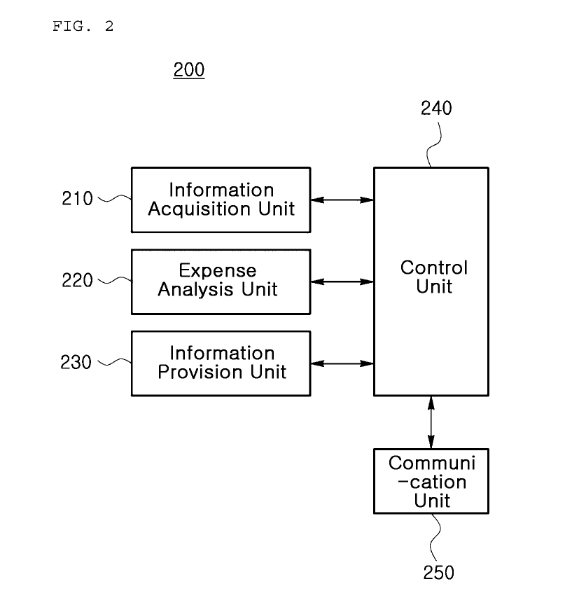

FIG. 2 illustratively shows the internal configuration of the information provision system according to one embodiment of the invention.

Referring to FIG. 2, the information provision system 200 according to one embodiment of the invention may comprise an information acquisition unit 210, an expense analysis unit 220, an information provision unit 230, a communication unit 240, and a control unit 250. According to one embodiment of the invention, at least some of the information acquisition unit 210, the expense analysis unit 220, the information provision unit 230, the communication unit 240, and the control unit 250 may be program modules to communicate with an external system (not shown). The program modules may be included in the information provision system 200 in the form of operating systems, application program modules and other program modules, while they may be physically stored in a variety of commonly known storage devices. Further, the program modules may also be stored in a remote storage device that may communicate with the information provision system 200. Meanwhile, such program modules may include, but are not limited to, routines, subroutines, programs, objects, components, data structures and the like for performing specific tasks or executing specific abstract data types as will be described below in accordance with the invention.

First, according to one embodiment of the invention, the information acquisition unit 210 may function to acquire information on an expense history of a user.

Here, according to one embodiment of the invention, the information on the expense history may include information on expenses incurred by the user in the past, in units of individual expenses (hereinafter, “expense units”). According to one embodiment of the invention, the information on the expense history may include, for example, text messages transmitted as expenses are incurred, and expense history information automatically generated based on text included in e-mail or the like, generated by financial institutions associated with the user, generated by shops or the like used by the user, or created at the user's discretion.

Specifically, according to one embodiment of the invention, the information on the expense history may include context information on expense units, and the context information may encompass information on an expense unit itself and a variety of information that may imply a situation in which the corresponding expense unit has been generated. For example, the context information may include information on an expense amount, expense time, expense location, expense type, expense theme, shop name, and whether a payment has been shared with others.

Meanwhile, as the user carries out a payment (i.e., an expense) using a credit card or check card, an expense history information management unit (not shown) according to one embodiment of the invention may derive significant information on the corresponding expense from text included in a text message, e-mail or the like transmitted to the corresponding user, thereby generating context information on the expense unit. Further, the expense history information management unit (not shown) according to one embodiment of the invention may further derive significant information on the place or location where the payment has been carried out, with reference to location information of the corresponding user device 300 at the time of transmission of the above text message, e-mail or the like (or receipt thereof at the user device 300).

Meanwhile, it is noted that the method of generating or managing expense history information according to the invention is not necessarily limited to the above description, and may be changed without limitation as long as the objects of the invention can be achieved.

Further, according to one embodiment of the invention, the information acquisition unit 210 may function to acquire schedule information of the user.

Here, according to one embodiment of the invention, the schedule information may include information on events that the user has carried out in the past, as well as information on events that the user will carry out in the future. Specifically, according to one embodiment of the invention, the schedule information may include context information on events, and the context information may encompass information on an event itself and a variety of information that may imply a situation in which the event has been generated or carried out. For example, the context information may include information on an event time, event location, event type, event keyword or topic, other users attending the event, and a note created for the event.

Meanwhile, it is noted that the context information on expense units or events according to the invention is not necessarily limited to the above description, and may be changed without limitation as long as the objects of the invention can be achieved.

Next, according to one embodiment of the invention, the expense analysis unit 220 may function to determine an expense expected to be incurred in an object event included in the schedule information of the user, with reference to context information on at least one expense unit associated with the object event among expense units included in the expense history information of the corresponding user.

Here, according to one embodiment of the invention, the object event, which is to be an object of expense analysis, may be an event in which an expense is expected to be incurred, judging from the context information on events or expense units. For example, the object event may be determined from an event including an expense-related keyword (e.g., “alumni reunion”, “meeting”, “lunch”, “party”, “monthly rent”, “wedding”, “birthday”, etc.), an event whose location is a restaurant or shop, an event whose location is where expenses have been frequently incurred in the past, an event whose time falls within time periods when expenses have been frequently incurred in the past, an event of meeting a person with whom expenses have been frequently incurred in the past, and the like. Further, according to one embodiment of the invention, the object event may be an event that the user will carry out in the future. For example, the object event may be determined from an event directly specified by the user, an event existing within a predetermined range of time from the current time, and the like.

Further, according to one embodiment of the invention, the expense analysis unit 220 may function to determine an expense expected to be incurred in the object event, with further reference to context information on at least one other event associated with the object event among other events included in the schedule information of the user, as well as the context information on the expense units.

Next, according to one embodiment of the invention, the information provision unit 230 may function to provide the user with information on the expected expense determined as above. Specifically, according to one embodiment of the invention, the information on the expense expected to be incurred in the object event may be provided to the user in the form of a notification, when the object event is generated or immediately before the object event begins.

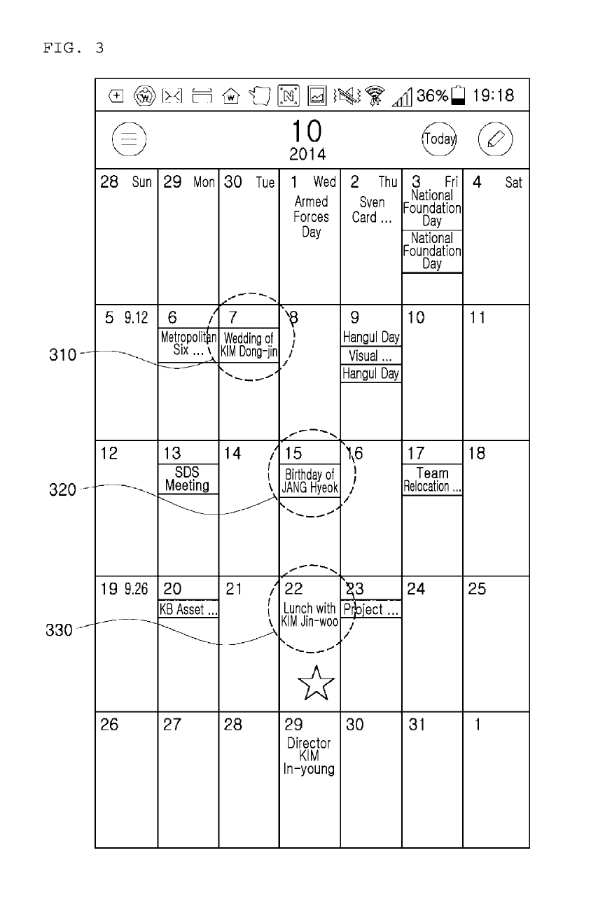

FIG. 3 illustratively shows how to analyze expected expenses according to one embodiment of the invention.

In the embodiment of FIG. 3, events 310, 320, 330 (i.e., “Wedding of KIM Dong-jin”, “Birthday of JANG Hyeok”, and “Lunch with KIM Jin-woo”) among events included in the October 2014 schedule of user A may be determined as events to be objects of expense analysis (i.e., object events).

Referring to FIG. 3, the expense analysis unit 220 according to one embodiment of the invention may expect that a money gift of fifty dollars ($50) will be expended in the event 310, “Wedding of KIM Dong-jin”, with reference to context information indicating that user A has expended an average amount of $50 for an expense unit associated with a wedding in the past. Referring further to FIG. 3, the expense analysis unit 220 according to one embodiment of the invention may expect that a taxi fare of $30 will be expended in the event 320, “Birthday of JANG Hyeok”, with reference to context information indicating that user A has expended an average taxi fare of $30 for a birthday of JANG Hyeok in the past. Referring further to FIG. 3, the expense analysis unit 220 according to one embodiment of the invention may expect that a meal price of $9 will be expended in the event 330, “Lunch with KIM Jin-woo”, with reference to context information indicating that user A has usually split the bill when having a meal with KIM Jin-woo and that user A has expended an average amount of $9 for a lunch.

Meanwhile, according to one embodiment of the invention, the expense analysis unit 220 may function to determine a recommended schedule comprising at least one event in which an expense conforming to a budget or policy of the user is incurred, with reference to information on the expected expenses determined as above and information on the budget or policy of the user.

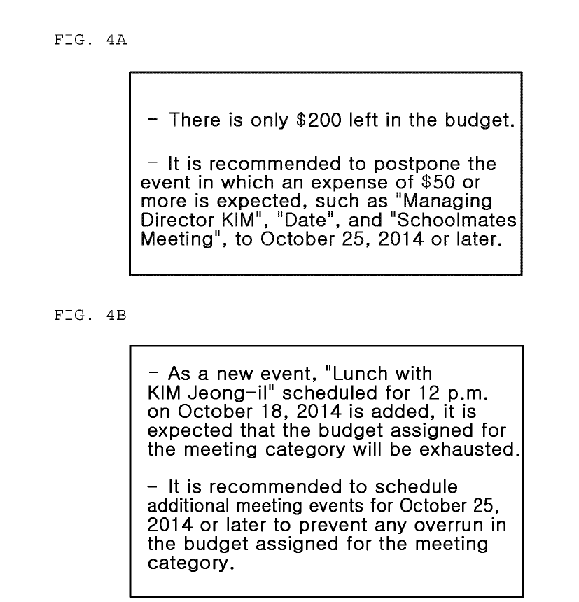

FIGS. 4A and 4B illustratively show how to recommend a schedule with reference to expected expenses according to one embodiment of the invention.

Referring to FIGS. 4A and 4B, when there is only $200 left in a budget predetermined for a time period from Sep. 25, 2014 to Oct. 25, 2014, the expense analysis unit 220 according to one embodiment of the invention may provide a notification indicating that it is recommended to postpone an upcoming event in which an amount of $50 or more is expected to be expended to Oct. 25, 2014 or later (see FIG. 4A). Referring further to FIGS. 4A and 4B, when it is expected that a budget predetermined for a meeting category will be exhausted as a new event falling under the meeting category is generated, the expense analysis unit 220 according to one embodiment of the invention may provide a notification indicating that it is recommended not to generate an additional event under the meeting category (see FIG. 4B).

Meanwhile, the communication unit 240 according to one embodiment of the invention may function to enable the information provision system 200 to communicate with an external device such as the user device 300.

Lastly, the control unit 250 according to one embodiment of the invention may function to control data flow among the information acquisition unit 210, the expense analysis unit 220, the information provision unit 230, and the communication unit 240. That is, the control unit 250 may control inbound data flow or data flow among the respective components of the information provision system 200, such that the information acquisition unit 210, the expense analysis unit 220, the information provision unit 230, and the communication unit 240 may carry out their particular functions, respectively.

Meanwhile, according to another embodiment of the invention, the information provision system 200 may function to provide the user with information on an expense expected to be incurred in a specific location or specific route, by acquiring expense history information and location history information, and determining an expense expected to be incurred in an object location or object route derived from the location history information, with reference to context information on at least one expense unit associated with the object location or object route among expense units included in the expense history information.

First, according to another embodiment of the invention, the information acquisition unit 210 may function to acquire expense history information and location history information of the user.

Here, according to another embodiment of the invention, the location history information may not only include information on a location itself in which the user has been in the past or a route itself in which the user has traveled in the past, but also context information on a past location or past route of the user. The context information may encompass a variety of information that may imply a situation in which the past location or past route of the user has been generated. For example, the context information may include information on past locations or past routes, time or frequency at which past locations or past routes have been generated, vehicles used in past routes, and a location of a place of residence or work estimated from past locations or past routes. However, the context information on locations or routes according to the invention is not necessarily limited to the above description, and may be changed without limitation as long as the objects of the invention can be achieved.

Next, according to another embodiment of the invention, the expense analysis unit 220 may function to determine an expense expected to be incurred in an object location or object route derived from the location history information, with reference to context information on at least one expense unit associated with the object location or object route among expense units included in the expense history information.

Further, according to another embodiment of the invention, the expense analysis unit 220 may function to determine an expense expected to be incurred in the object location or object route, with further reference to context information on past locations or past routes associated with the object location or object route among locations or routes included in the location history information of the user, as well as the context information on the expense units.

Here, according to another embodiment of the invention, the object location or object route, which is to be an object of expense analysis, may be a location or route in which the user will shortly stop or pass and an expense is expected to be incurred, judging from the context information on the past locations or past routes and that on the expense units. For example, the object location may be determined from locations of late-night hours in which expenses have been frequently incurred at Internet shopping malls, and the object route may be determined from routes of morning rush hours in which taxi fares have been frequently expended. Further, according to another embodiment of the invention, the object location or object route may be a location or route specified at the user's discretion.

Further, according to another embodiment of the invention, the expense analysis unit 220 may generate recommendation information on a location or route in which an expense conforming to a budget or policy of the user is incurred, with reference to information on the expected expenses determined as above and information on the budget or policy of the user.

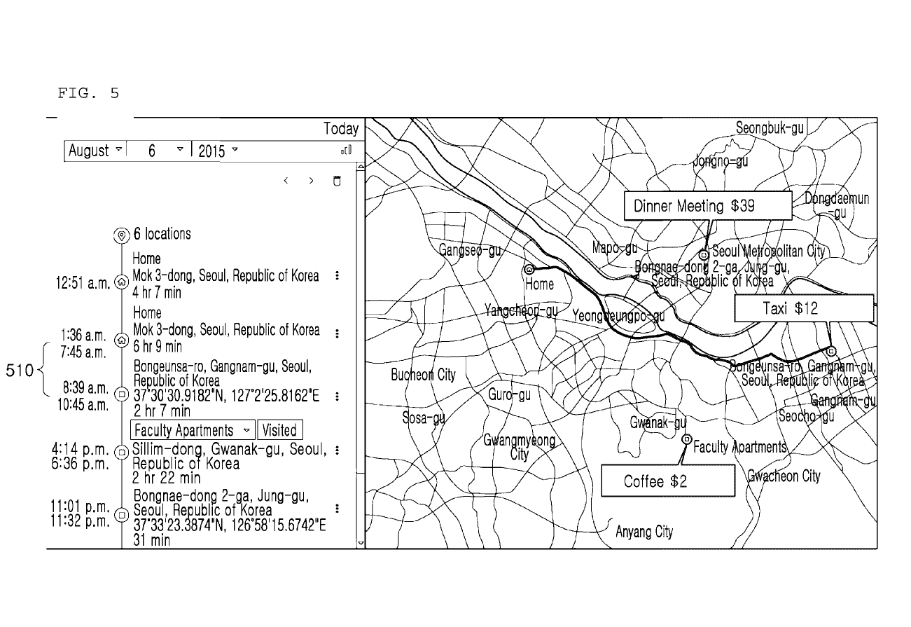

FIG. 5 illustratively shows how to provide a recommendation for a route with reference to expected expenses according to another embodiment of the invention.

Referring to FIG. 5, the expense analysis unit 220 according to another embodiment of the invention may provide user A with a notification indicating that it is recommended to travel by subway or bus rather than taxi in morning hours on weekdays, with reference to context information indicating that user A has frequently expended taxi fares in a route 510 from his/her residence to work in morning hours around 8:00 a.m. on weekdays.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for providing information on expense management, comprising the steps of:
acquiring expense history information and schedule information of a user; and
determining an expense expected to be incurred in an object event included in the schedule information, with reference to context information on at least one expense unit associated with the object event among expense units included in the expense history information.

2. The method of claim 1, wherein the context information on the at least one expense unit includes information on at least one of an expense amount of the at least one expense unit, an expense time of the at least one expense unit, an expense location of the at least one expense unit, an expense type of the at least one expense unit, an expense theme of the at least one expense unit, a shop name in the at least one expense unit, and whether a payment has been shared in the at least one expense unit.

3. The method of claim 1, wherein the object event includes at least one of an event in which an expense equal to or greater than a predetermined level is expected to be incurred, an event existing within a predetermined time from a current time, and an event selected by the user.

4. The method of claim 1, wherein in the determining step, the expense expected to be incurred in the object event is determined with further reference to context information on at least one other event associated with the object event among other events included in the schedule information of the user.

5. The method of claim 4, wherein the context information on the at least one other event includes information on at least one of a time of the at least one other event, a location of the at least one other event, a type of the at least one other event, a keyword or topic of the at least one other event, other users attending the at least one other event, and a note for the at least one other event.

6. The method of claim 1, further comprising the step of:
determining a recommended schedule comprising at least one event in which an expense conforming to a budget or policy of the user is incurred, with reference to information on the determined expected expense and information on the budget or policy of the user.

7. The method of claim 1, further comprising the step of:
providing the user with information on the determined expected expense.

8. A method for providing information on expense management, comprising the steps of:
acquiring expense history information and location history information of a user; and
determining an expense expected to be incurred in an object location or object route derived from the location history information, with reference to context information on at least one expense unit associated with the object location or object route among expense units included in the expense history information.

9. The method of claim 8, wherein the object location or object route includes at least one of a location or route in which an expense equal to or greater than a predetermined level is expected to be incurred, a location or route in which the user will stop or pass within a predetermined time, and a location or route selected by the user.

10. The method of claim 8, wherein in the determining step, the expense expected to be incurred in the object location or object route is determined with further reference to context information on past locations or past routes associated with the object location or object route among locations or routes included in the location history information of the user.

11. The method of claim 10, wherein the context information on the past locations or past routes includes information on at least one of the past locations or past routes, time or frequency at which the past locations or past routes have been generated, vehicles used in the past routes, and a location of a place of residence or work estimated from the past locations or past routes.

12. A non-transitory computer-readable recording medium having stored thereon a computer program for executing the method of claim 1.

13. A system for providing information on expense management, comprising:
an information acquisition unit for acquiring expense history information and schedule information of a user; and
an expense analysis unit for determining an expense expected to be incurred in an object event included in the schedule information, with reference to context information on at least one expense unit associated with the object event among expense units included in the expense history information.

14. A system for providing information on expense management, comprising:
an information acquisition unit for acquiring expense history information and location history information of a user; and
an expense analysis unit for determining an expense expected to be incurred in an object location or object route derived from the location history information, with reference to context information on at least one expense unit associated with the object location or object route among expense units included in the expense history information.
